(19) United States
(12) Patent Application Publication
(10) Pub. No.: US 2010/0296909 A1
(43) Pub. Date: Nov. 25, 2010

(54) STRUCTURALLY REINFORCED SULFUR BLOCKS AND PROCESSES OF MAKING

(76) Inventors: Edward Mierzewski, Edmonton (CA); Irina Mierzewski, Edmonton (CA)

Correspondence Address: DYKAS, SHAVER & NIPPER, LLP, P.O. BOX 877, BOISE, ID, 83701-0877, US

(21) Appl. No.: 12/811,588

(22) PCT Filed: Aug. 27, 2009
(86) PCT No.: PCT/CA2009/001168

§ 371 Date: Jul. 2, 2010

Related U.S. Application Data
(60) Provisional application No. 61/092,390, filed on Aug. 27, 2008.

(51) Int. Cl. B65G 49/00; B32B 9/00

(52) U.S. Cl. 414/800; 264/235; 264/279.1; 428/34.1

(57) ABSTRACT

Sulfur is conventionally stored in solid form and melted to be transported in liquid form or transformed into small pellets, called prills or small briquettes. Transportation of solid sulfur can result in dust creation, exposure to weather and moisture, and corrosion of the transport equipment. The present invention discloses a method of making structurally reinforced blocks of sulfur, sized for transport. The blocks are structurally reinforced with an internal structure, by layering during manufacturing or by an external structure frame or container. A protective coating can be applied.

### TECHNICAL FIELD

This document relates to the field of transporting sulfur.

### BACKGROUND

Generally, in Alberta, Canada, sulfur is produced in excess of market demand as a by product of oil and gas processing. Due to the normal low price of the commodity, the produced sulfur is stockpiled in (huge) outdoor blocks. These outdoor blocks are often stored in remote locations at or near processing facilities. When the fluctuating price of sulfur reaches a high point, the sulfur blocks are remelted and shipped by conventional methods.

Sulfur has traditionally been transported in its elemental form as a liquid, or as a prilled or small briquette solid. These modes of transportation have evolved in general from earlier transport in the form of crushed solid. Crushed solid transport has been legislated as unacceptable because sulfur dust is flammable/explosive and a pollutant.

As a liquid, sulfur is a dangerous good as defined in government legislation concerning transportable substances. Despite this, the liquid form has been the preferred mode of rail or truck transportation for continental deliveries.

Sulfur transported as a prilled solid is primarily destined for ocean transport. In the 1960s or so, when this form of sulfur was devised for transportation, bulk shipments of commodities were the common mode of international transport of goods.

Producing prilled sulfur requires a separate license for a prilling facility in Alberta. These facilities can expose high surface areas of hot sulfur to the atmosphere and therefore must be constructed to minimize pollution. Further, the processes used are complicated and expensive.

Sulfur prills are, for the most part, transported in open rail cars and in ocean going vessels. Exposure to weather and moisture, along with the high surface area, tends to produce sulfur type acids that corrode transport equipment. Moisture adsorbed onto and absorbed into the product can add to subsequent processing costs when the moisture must later be removed.

Producing small briquettes is expensive and requires complex infrastructure. In addition, these briquettes cannot be easily transported, as they have a large surface area for contact dust creation, and they must be kept in bags or contained in small packets.

According, it is clear there is a need for a simple, inexpensive mode of production of transportable sulfur over conventionally known methods. Patterns of commerce have been changing, and more and more trade is now done in the form of finished goods. Containerization as a mode of transport has evolved. Efficient global infrastructure for transporting containerized goods is now available. An interesting situation that is currently occurring is that there is a net flow of containers into North America that is not counterbalanced by flow of containers out of North America.

### SUMMARY

A method of transporting sulfur is disclosed, comprising: transporting a structurally reinforced sulfur block from a first location to a second location by machine. A structurally reinforced sulfur block for machine transport is also disclosed. A method of forming structurally reinforced sulfur blocks for machine transport is also disclosed.

A process is also described for producing structurally reinforced blocks of sulfur which then can be moved with conventional equipment from production to consumption points.

A structurally reinforced sulfur block is also disclosed, the structurally reinforced sulfur block being liftable by freight lifting equipment, and dimensioned to fit within a single transport container.

A transport container loaded with at least one of the disclosed sulfur blocks is also disclosed. A method comprising removing at least one structurally reinforced sulfur block from the transport container is also disclosed. A method comprising adding at least one structurally reinforced sulfur block to the transport container to produce the transport container is disclosed.

These and other aspects of the device and method are set out in the claims, which are incorporated here by reference.

The concept of forming sulfur into structurally reinforced blocks larger than prills or briquettes for transporting the element is novel. This is understandable given the uncommonality of containerization as a mode of transport at the time prilling was developed, and the acceptance of flowable bulk transport or tanked liquid transport as norms of the day.

### BRIEF DESCRIPTION OF THE FIGURES

Embodiments will now be described with reference to the figures, in which like reference characters denote like elements, by way of example, and in which:

FIG. 1 is a perspective view of an exemplary structurally reinforced Sulfur block. FIG. 1 shows an exemplary mini block of sulfur. The top dimensions may be, for example, 3′ D×5′ W. The height is 4′. There may be a 1′ top lip on the block. The bottom 3′ of the block is tapered. The top lip provides a flat surface for blocks to butt up against each other, which should reduce the chance of chipping. The bottom taper facilitates removal from the mold.

FIG. 2 is an end elevation view of an exemplary structurally reinforced Sulfur block being picked up by a lift fork. FIG. 2 illustrates how a taper in a block can be used to facilitate handling with a forked type carrier.

FIG. 3 is an end elevation view of an exemplary structurally reinforced sulfur block with slots adapted for pickup by a fork lift.

FIG. 4 is an end elevation view of a further embodiment of a structurally reinforced sulfur block with raised shoulders adapted for pickup by a fork lift.

FIG. 5 is a perspective view of a plurality of structurally reinforced sulfur blocks positioned in a transport container, the transport container dimensions illustrated partially with ghost lines.

FIG. 6 is a perspective view of a plurality of structurally reinforced sulfur blocks loaded on a transport truck bed.

FIG. 7 is an end elevation view of two structurally reinforced sulfur blocks stacked on one another.

FIG. 8 is a perspective partial cut-away view of a structurally reinforced sulfur block containing reinforcing material.

FIG. 9 is a flow diagram illustrating a method of forming a structurally reinforced sulfur block.

FIG. 10 is a flow diagram illustrating a further method of forming a structurally reinforced sulfur block by molding.

FIG. 11 is a flow diagram illustrating a method of loading a structurally reinforced sulfur block.

FIG. 12 is a flow diagram illustrating a method of unloading a structurally reinforced sulfur block from a transport container.

FIGS. 13A-C is a series of section views of a structurally reinforced sulfur block forming molding process.

FIGS. 14A-B are a series of section views of a structurally reinforced sulfur block-forming layer molding process.

FIGS. 15A-B are a series of section views of another structurally reinforced sulfur block-forming layer molding process.

FIG. 16 is a side elevation view, in section, of a structurally reinforced sulfur block comprising an external structural frame.

FIG. 17 is a side elevation view of external structural frames stacked together.

### DETAILED DESCRIPTION

Immaterial modifications may be made to the embodiments described here without departing from what is covered by the claims.

The process disclosed herein calls for the use of smaller structurally reinforced transportable blocks of sulfur (as opposed to the large industrial storage blocks found at well sites, for example) that can be lifted with conventional lifting equipment, such as for example forklifts, telehandlers, freight-lifting cranes, or similar equipment for placement into standard or non-standard containers for transport.

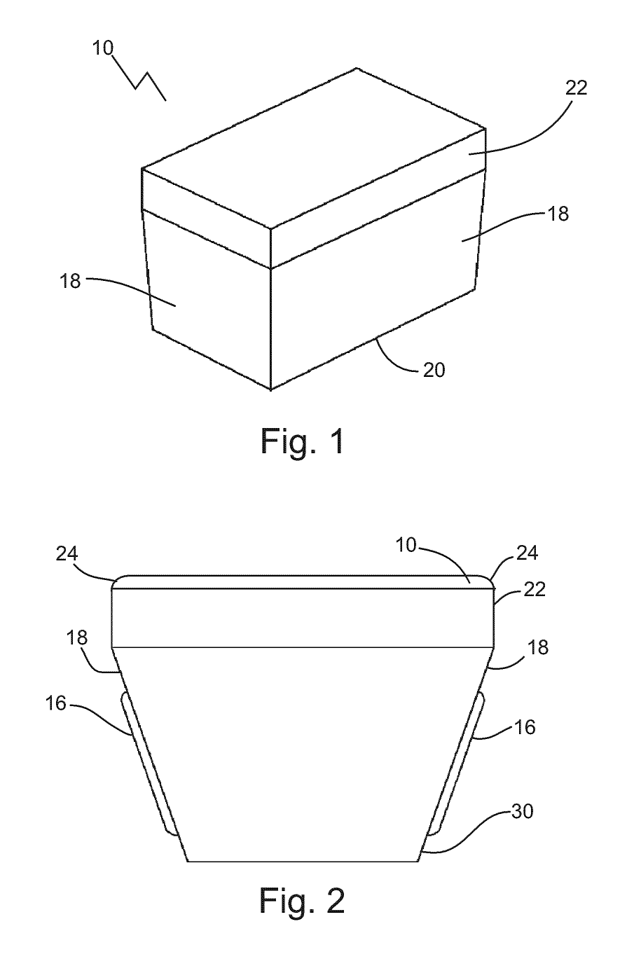

Referring to FIG. 1, a structurally reinforced sulfur block 10 for machine transport is illustrated. Block 10 may have a weight of at least 10 pounds, and may be liftable by freight lifting equipment and dimensioned to fit within a single transport container. The structurally reinforced sulfur block may have a weight of at least, for example, 100-20000 pounds. In some embodiments, the block 10 may have a weight of at least 2000 pounds. An exemplary weight range of 2000-2500 pounds may be a preferable range for machine transport by freight lifting equipment. In some embodiments, the structurally reinforced sulfur block may have a weight that is even greater than 20000 pounds, so long as it is within the weight restrictions of the mode of transport through which it will be transported, for example by truck, transport container, air freight, or railcar. Referring to FIG. 2, in some embodiments the structurally reinforced sulfur block 10 may be dimensioned such that a single structurally reinforced sulfur block 10 may be picked up by a conventional forklift. In FIG. 2, only the lifting fork arms 16 of the forklift are illustrated.

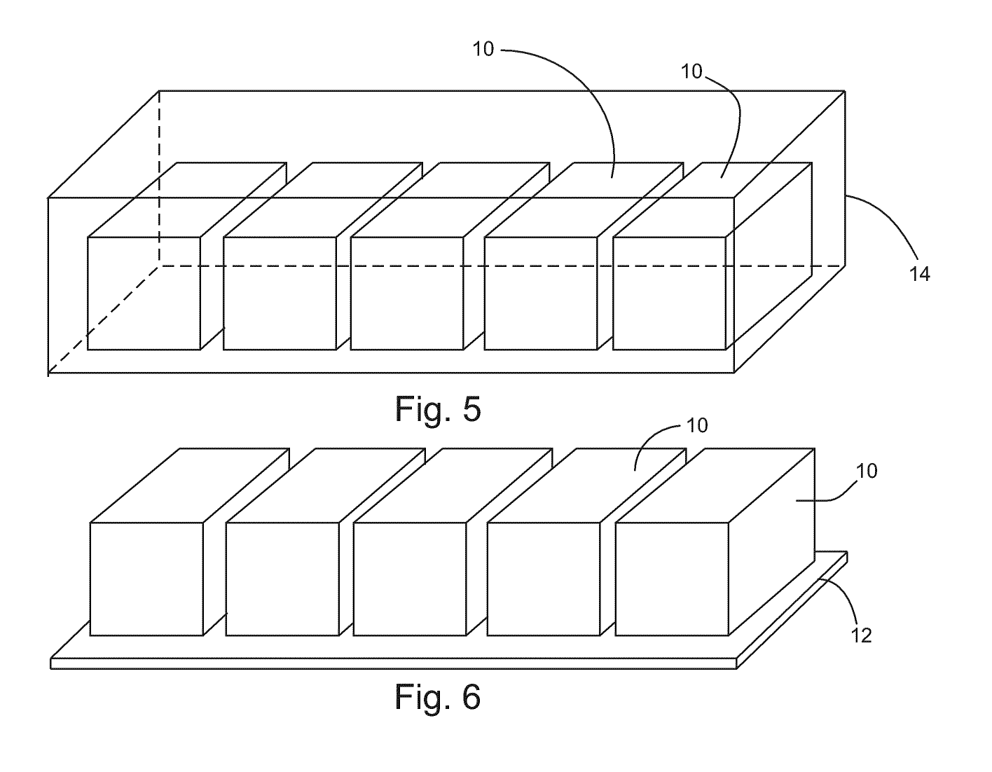

Liftable by freight lifting equipment refers to the fact that the structurally reinforced sulfur block may be able to be lifted by conventional freight lifting equipment—in other words, the block may be not too large to be transported by freight handling equipment in a conventional fashion. Because of the standardization of transport containers in the intermodal freight industry, the structurally reinforced sulfur block may be dimensioned to fit within a single transport container. However, it is understood that structurally reinforced sulfur blocks contained within the scope of this document need not be transported only by container, as is illustrated in FIG. 5. Referring to FIG. 6, an embodiment is illustrated in which a plurality of structurally reinforced sulfur blocks 10 are positioned for transport on a truck bed 12.

Referring to FIG. 5, an exemplary transport container 14 is illustrated comprising, for example housing, one or more structurally reinforced sulfur blocks 10. Examples of standard transport containers are illustrated below in Table 1. It should be understood that various other sizes and shapes of transport containers are envisioned within the scope of this document, and the dimensions illustrated in Table 1 are not intended to be in any way limiting. Further examples of transport containers include air freight transport containers, which are generally smaller in size from the standard intermodal freight containers used primarily in the rail and ship industries. In some embodiments, the structurally reinforced sulfur block is between 1 and 8.5 feet in height from the base. It should be understood that the restricted height of the transport container 14 or the truck bed 12 (illustrated in FIG. 6) for example, may put restrictions on the height of the structurally reinforced sulfur block 10. Similarly, the width and depth of a structurally reinforced sulfur block 10 may be similarly limited by width and depth restrictions. Referring to FIG. 2, in some embodiments, the structurally reinforced sulfur block may have a width that is sized for pickup by the tines 16 of freight lifting equipment, for example if the width is at least 3 feet. The weight restrictions of the mode of transport may also limit the number of structurally reinforced sulfur blocks 10 that are safely able to be transported, as well as the weight of each individual structurally reinforced sulfur block 10. In some embodiments, the block is at least 15 ft³ in volume. In other embodiments, the block is 20-250 ft³ in volume. In further embodiments, the block may be much larger.

TABLE 1
Examples of transport container dimensions and statistics

| | | 20′ container | | | | 40′ container | | | | 45′ high-cube container | | | |
|---|---|---|---|---|---|---|---|---|---|---|---|---|---|
| | | Imperial | | metric | | imperial | | metric | | imperial | | metric | |
| external | length | 20′ | 0″ | 6.096 | m | 40′ | 0″ | 12.192 | m | 45′ | 0″ | 13.716 | m |
| dimensions | width | 8′ | 0″ | 2.438 | m | 8′ | 0″ | 2.438 | m | 8′ | 0″ | 2.438 | m |
| | height | 8′ | 6″ | 2.591 | m | 8′ | 6″ | 2.591 | m | 9′ | 6″ | 2.896 | m |
| interior | length | 18′ | 10 5/16″ | 5.758 | m | 39′ | 5 45/64″ | 12.032 | m | 44′ | 4″ | 13.556 | m |
| dimensions | width | 7′ | 8 19/32″ | 2.352 | m | 7′ | 8 19/32″ | 2.352 | m | 7′ | 8 19/32″ | 2.352 | m |
| | height | 7′ | 9 57/64″ | 2.385 | m | 7′ | 9 57/64″ | 2.385 | m | 8′ | 9 15/16″ | 2.698 | m |
| door aperture | width | 7′ | 8⅛″ | 2.343 | m | 7′ | 8⅛″ | 2.343 | m | 7′ | 8⅛″ | 2.343 | m |
| | height | 7′ | 5¾″ | 2.280 | m | 7′ | 5¾″ | 2.280 | m | 8′ | 5 49/64″ | 2.585 | m |

| | | | | | | | | | | | | |
|---|---|---|---|---|---|---|---|---|---|---|---|---|
| volume | 1,169 | ft³ | 33.1 | m³ | 2,385 | ft³ | 67.5 | m³ | 3,040 | ft³ | 86.1 | m³ |
| maximum gross mass | 52,910 | lb | 24,000 | kg | 67,200 | lb | 30,480 | kg | 67,200 | lb | 30,480 | kg |
| empty weight | 4,850 | lb | 2,200 | kg | 8,380 | lb | 3,800 | kg | 10,580 | lb | 4,800 | kg |
| net load | 48,060 | lb | 21,600 | kg | 58,820 | lb | 26,500 | kg | 56,620 | lb | 25,680 | kg |

Referring to FIG. 5, an embodiment is illustrated in which the structurally reinforced sulfur block 10 is dimensioned to fit in groups of two or more structurally reinforced sulfur blocks 10 within a single transport container 14. In other embodiments, the structurally reinforced sulfur block 10 is dimensioned to fit in groups of between two and a thousand structurally reinforced sulfur blocks 10 within a single transport container 14. The optimum size of structurally reinforced sulfur block 10 used may depend on the type of freight handling equipment employed, as well as the size of the transport container 14.

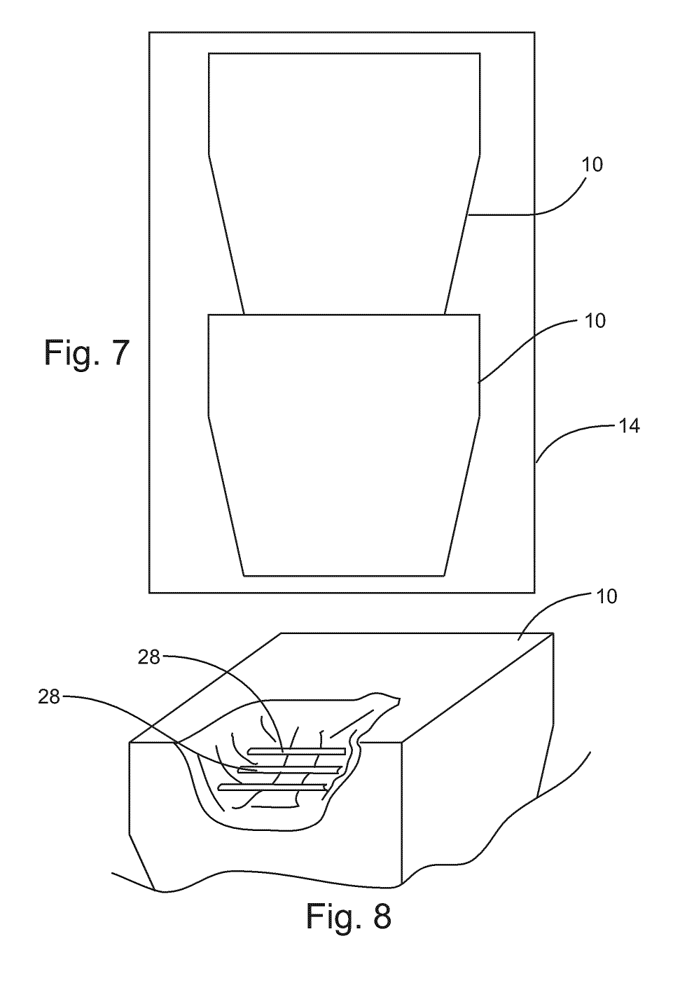

Referring to FIG. 7, an embodiment is illustrated in which the structurally reinforced sulfur block 10 is stackable in groups of two or more structurally reinforced sulfur blocks 10 within a single transport container 14. It should be understood that stacking may be more important for transporting smaller sizes of structurally reinforced sulfur blocks 10. In order to be stackable in a standard transport container 14, the structurally reinforced sulfur block 10 may be between 1 and 4.5 feet in height, although this may depend on the specific type of container employed, if any, and on the number of blocks 10 stacked upon one another.

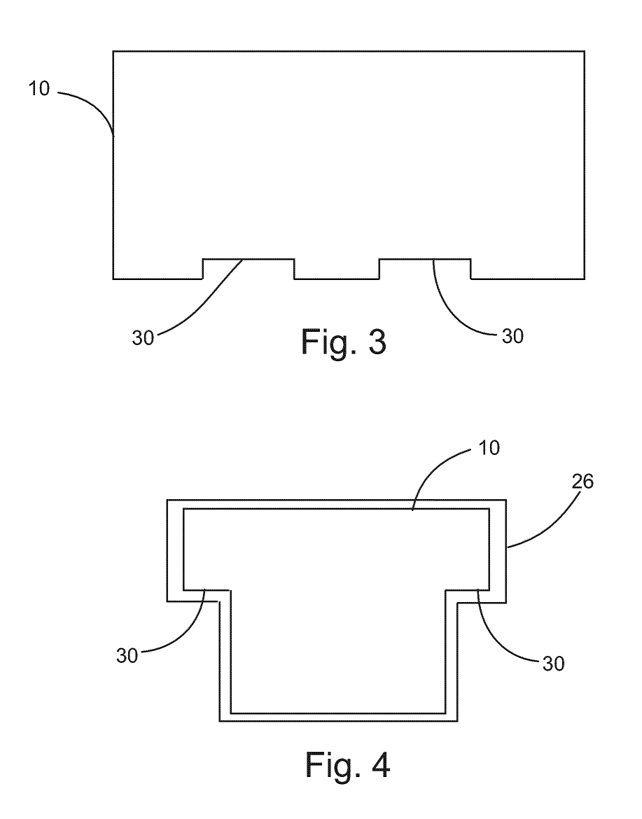

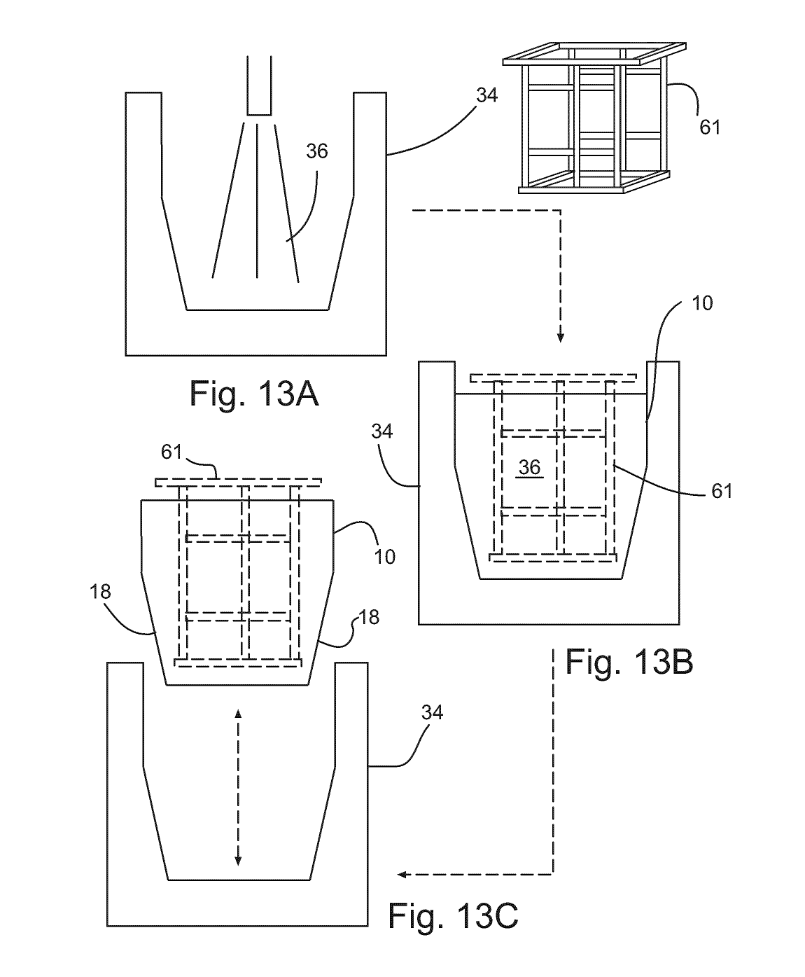

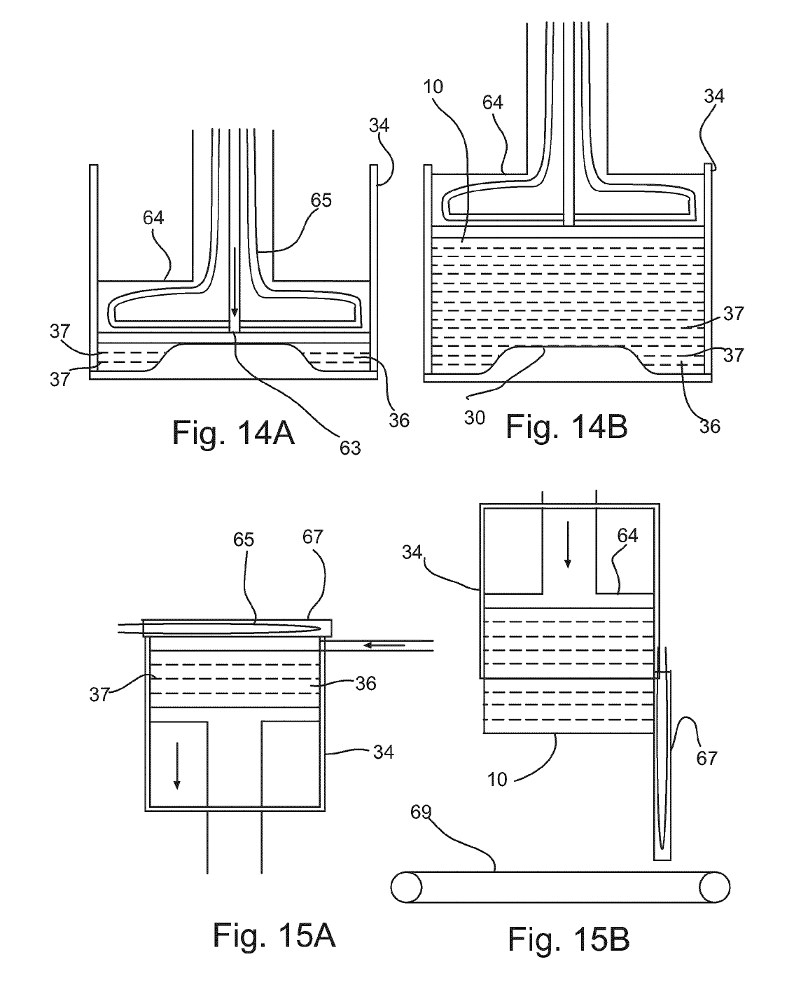

Referring to FIG. 2, an embodiment is illustrated in which a structurally reinforced sulfur block 10 has at least one tapered side 18. Referring to FIG. 13C, and further described in greater detail below, tapered sides 18 may enhance the removal of structurally reinforced sulfur block 10 from a mold 34. Referring to FIG. 2, tapered sides 18 may also be adapted to be easily handled by freight handling equipment, such as forklift arms or tines 16. Referring to FIG. 1, in the embodiment illustrated, tapered sides 18 surround the base 20 of block 10. In some embodiments, tapered sides 18 may only surround two or more of the actual sides of block 10. Referring to FIGS. 3 and 4, block 10 may comprise at least one molded shoulder 30 to facilitate lifting with a forklift. Referring to FIG. 2, molded shoulder 30 may be, for example, tapered sides 18. Referring to FIGS. 3 and 14B, molded shoulder 30 is illustrated as two separate slots and a single large slot, respectively, into which fork arms such as tines (not shown) may be used to lift block 10. Referring to FIG. 4, molded shoulders 30 are illustrated as being located partially up the sides of block 10. The shoulders 30 illustrated in FIGS. 2 and 4 may be more advantageous for handling using specialized types of forklifts, for example telehandlers. Molded shoulder(s) give the block 10 a profile for freight lifting equipment to contact to stably lift the block 10.

Referring to FIGS. 1 and 2, block 10 comprises a lip 22 for contact with other structurally reinforced sulfur blocks 10. Lip 22 may be a wider portion of the sides of block 10, in order to ensure that other blocks 10 will contact lip 22, and not other regions of a block 10, such as tapered sides 18 for example. Lip 22 may be an upper lip, for example as shown. Lip 22 reduces the surface area of block 10 that may contact other blocks 10 or other adjacent transport structure, thus reducing the potential for the creation of hazardous sulfur dust which may occur under the rigors of close proximity transport. Further modifications may be made to further reduce the potential for dust creation, including providing rounded or curved sides (not shown), or by simply rounding at least one of the edges of block 10. Referring to FIG. 2, this is illustrated in the form of at least one rounded edge 24. Lip 22 may be part of a tapered side 18.

Referring to FIG. 4, the structurally reinforced sulfur block 10 may be structurally reinforced by application of a protective external coating 26. Protective covering 26 may comprise, for example, at least one of plastic, rubber, concrete, syran, sulfur alloy, hardening chemicals, wood, and metal. For example, the protective covering 26 may be a thick wax coating which is applied as a liquid to the outer surfaces of block 10. Protective covering 26 may further reduce the environmental exposure of block 10 to elements such as water, wind, and debris—elements which may otherwise create hazards.

Referring to FIG. 8, block 10 may be structurally reinforced by inclusion of reinforcing material 28. A cut-away of a such a block 10 is illustrated containing rebar. The reinforcing material 28 may aid in improving the structural integrity of block 10 for transport, and material 28 may be removed upon the remelting or crushing of block 10 upon reaching its destination. The reinforcing material may comprise, for example, at least one of mesh, particulate, rods, rebar, and an internal structural frame. In some embodiments, the structurally reinforced sulfur block may be formed by inserting heated reinforcing material, such as rebar 28, when the sulfur block is solid. The heated reinforcing material may be hollow rods for easy insertion, and may be connected to a power source for resistively heating along the length of the reinforcing material as the material is inserted.

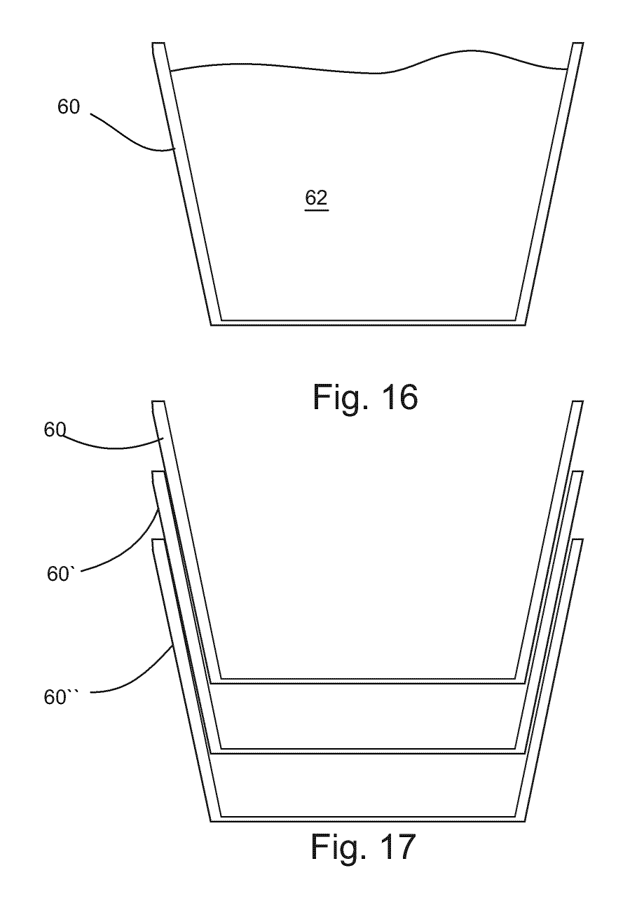

Referring to FIG. 16, in some embodiments the block 10 may be structurally reinforced by an external structural frame 60, such as a bin as shown. Exposed surfaces of the block, such as the top in the case of a bin, may be covered during transport, for example using a lid (not shown). An external structural frame may at least partially surround the block 10, and may support the block entirely. This approach may involve forming the block 10 in the external structural frame 60, for example if liquid sulfur is molded in frame 60. The sulfur may be solidified with the top of the bin open to the environment or covered, although the open-topped cooling method is expected to produced a thicker crust and thus a block that is more suitable for transport. The frame 60 and sulfur 62 may then be transported together. Referring to FIG. 17, the external structural frame 60 may be dimensioned to stack at least partially within a second external structural frame 60′ with the same dimensions as the external structural frame 60. More than two frames 60 may be stacked, for example as shown with third frame 60′. Thus, sulfur 62 may be transported in a structurally reinforced form, and external structural frames 60 may be returned in a stacked fashion for space savings. Bins allow this type of stacking, as they may have tapered sides that allow one bin to slide into another bin, much like a series of breadpans.

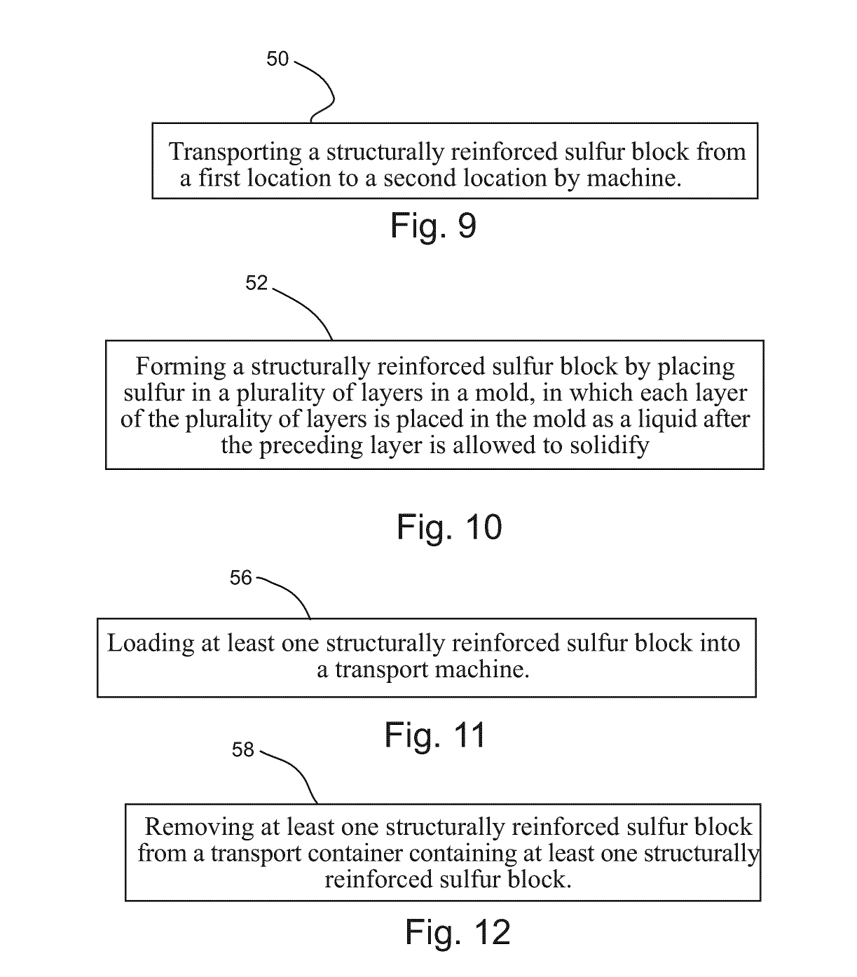

Referring to FIG. 9, a method of transporting sulfur is illustrated. Referring to FIG. 6, in a stage 50, a structurally reinforced sulfur block 10 is transported from a first location to a second location by machine, for example tractor trailer (truck bed shown only).

The methods disclosed herein may comprise forming any of the structurally reinforced sulfur blocks 10 disclosed herein. It should be understood that there are various ways of forming the solid blocks 10 disclosed herein, such as by molding, compression, or by carving and buffing out smaller blocks from a larger block.

Referring to FIGS. 13A-C, a method is illustrated of forming a sulfur block 10. Sulfur 36 is placed in a mold 34 along with reinforcing material, such as an internal structural frame 61, to form a sulfur block 10. For example a supply of molten sulfur may be poured into an open top mold to form block 10. An open top mold has the advantage of allowing relatively easy height adjustments to change the weight of the finished block. Sulfur solidifying in the mold 34 may shrink slightly, which facilitates removal. To enhance removal, an open top mold may have vertical sides and/or can be tapered from bottom to wider top in a manner that enhances removal, as illustrated for example in FIG. 13C. Referring to FIG. 13C, the structurally reinforced sulfur block 10 may be removed from the mold 34 upon solidification. Referring to FIGS. 13A and B, the method may also include melting the sulfur 36 to form sulfur block 10, and further comprising allowing the sulfur 36 to solidify prior to removal from the mold 34. As illustrated in FIG. 13A, the sulfur 36 may be melted prior to placement in the mold 34. This may be advantageous, particularly when existing sulfur re-melting equipment is used to melt sulfur 36 from a larger industrial storage block, as it would negate the need for handling crushed or partially crushed sulfur.

In order to facilitate removal of the block 10 from the mold 34, various mechanisms may be employed. For example, at least one hook mechanism may be embedded within the top of block 10, and the block 10 can then be lifted from the mold 34 via the hook mechanism. In another embodiment, vacuum suction may be employed to draw the block 10 out of the mold 34.

In other embodiments, sulfur 36 may be melted after placement in the mold. In further embodiments, the sulfur 36 may be melted in a continuous flow through oven (not shown), which may use infrared heating technology for example. In such embodiments, the sulfur 36 may be placed in the mold 34 in an at least partially crushed form, and then heat may be applied to melt the sulfur. In this way, partially crushed sulfur may be fed into a series of molds 34 on a conveyor-type-apparatus (not shown), which may in turn carry the molds 34 into the continuous flow through oven to melt the sulfur and form the block 10.

In some embodiments, the methods disclosed herein may involve assisted cooling stages, using cooling techniques, such as placing mold 34 with sulfur 36 into a vat of room temperature water for example, or by providing internal coolant circulation within the walls of mold 34.

Referring to FIG. 13B, the method may comprise adding reinforcing material such as frame 61 to the sulfur 36. Internal frame 61 may be fully internal to block 10, or partially internal as shown. An internal frame 61 that extends out of block 10 may be used for handling block 10 as a hook mechanism. The reinforcing material may be added by addition to mold 34, for example, prior to adding liquefied or solid sulfur, or while the sulfur is in a liquid, semi-liquid, or partially crushed state. It should be understood that molding may incorporate other types of molding not disclosed, for example injection or cavity molding.

Any of the methods disclosed herein may further incorporate molds 34 coated to allow easy removal of the structurally reinforced sulfur block 10. Mold coatings or choice of mold lining material may assist the removal process. For example, mold 34 may be coated with reduced friction materials, such as Teflon, in order to aid the removal of block 10 from mold 34 (shown in FIG. 13C). As can be seen from FIGS. 13A-13C, the shape of mold 34 will determine the shape of block 10. Referring to FIG. 13B, one advantage of using an open-topped mold 34, such as the one indicated, is such that the height of block 10 may be easily modified, either by shaving, polishing, or selectively draining, for example. Of course, mini blocks of sulfur can be formed in cavity molds or by compacting solid sulfur, as well.

Sulfur can also be prepared in a stagewise fashion to enhance the mechanical properties for the purpose of shipping. An example of this is where the structurally reinforced sulfur block 10 is structurally reinforced by layering, for example layering during molding. Referring to FIG. 10, an exemplary method of forming such a block is illustrated. Referring to FIGS. 14A-B, in a stage 52 (shown in FIG. 10), the structurally reinforced sulfur block 10 is formed by placing sulfur 36 in a plurality of layers 37 (denoted by dashed lines) in a mold 34, in which each layer 37 of the plurality of layers is placed in the mold 34 as a liquid after the preceding layer is allowed to solidify, for example allowed to cool below 90° C. This way, the block 10 formed will have a higher density, greater stability, and greater strength for transport than achieved simply by basic molding sulfur on its own alone. The shrinking discussed above and observed during basic molding of sulfur is due to the fact that as sulfur is solidified it converts to the orthorhombic and amorphous forms and increases in density, often forming a rigid crust, a soft, crumbly interior, and internal voids or weak spaces in larger blocks. Layering prevents the formation of such voids or weak spaces during molding, by ensuring that each layer has sufficiently solidified and densified before additional layers are added. As shown, sulfur may be injected from one or more inputs 63, which may be located in a piston 64. Inputs 63 may comprise, for example, a plurality of inputs 63 through the face of piston 64. Referring to FIG. 15A, input 63 may be located at other suitable points, for example at the lid end of mold 34 opposite the piston 64. Referring to FIGS. 14A-B, liquid coolant may be employed, for example in coolant lines 65 located in the piston 64, in order to quicken the solidification of each layer 37. Coolant lines 65 may be located in other suitable regions of mold 34, such as in the lid 67 of mold 34 as is shown in FIG. 15A. Referring to FIGS. 14A-B, in some embodiments each layer may be approximately as thick as the thickness of dense crust naturally formed during basic molding of sulfur, for example if each layer is 1 inch thick or less. A controller (not shown) such as a logic controller may be used in order to operate the process. Logic controllers may be advantageously used in this fashion for automation and efficiency. The controller may use sensors, such as temperature sensors, in order to determine when a following layer 37 is added. Each layer 37 may be deposited as follows: piston 64 injects liquid sulfur 36 into the mold 34. Coolant in coolant lines 65 draws heat energy away from the injected liquid sulfur, allowing the sulfur to cool and densify. Piston 64 may apply pressure during this step, in order to further densify the formed layer 37. Once layer 37 has suitably densified, piston 64 is withdrawn far enough to form the next layer 37, and the process is repeated until a block 10 of suitable size is formed. In some embodiments, layering is done to exclude air in the resulting block.

Referring to FIGS. 15A and 15B, in the embodiment shown, layers are formed in mold 34 as piston 64 is withdrawn downwards, and sulfur 36 is injected at or near the lid 67. Once the block 10 has reached a suitable number of layers 37, the mold 34 may be rotated and lid 67 opened, in order to dispense block 10 out of mold 34. Block 10 may be dispensed onto a conveyor 69, which itself may transport the block 10 to freight lifting equipment or further processing, for example. Piston 64 may assist in dispensing block 10 out of mold 34.

In some embodiments, the structurally reinforced sulfur block 10 is structurally reinforced by annealing. Referring to FIG. 13B, this may be achieved by annealing sulfur 36 in mold 34 at, for example a temperature between 40 and 90° C., for a sufficient length of time to form the desired density or strength. This may be done in addition to or instead of adding reinforcing material as is shown.

In some embodiments, the desired average density of the sulfur in the structurally reinforced sulfur block is greater than the average density achieved by basic molding alone. The average density of the sulfur in the structurally reinforced sulfur block is calculated using the entire volume of sulfur in the block, including the volume of void spaces, if any, but not including the volume taken up, or introduced, by reinforcing material, if present. In some embodiments, the desired average density is at least 1.85 g/cm³, for example between 1.88 and 2.10 g/cm³. Sulfur blocks formed by layering during molding according to the disclosure of this document were measured to have a density of 1.89 g/cm³, whereas sulfur blocks formed by basic molding were measured to have a density of 1.78 g/cm³.

A method of forming a structurally reinforced sulfur block 10 may incorporate applying a protective covering 26 (shown in FIG. 4) to form the structurally reinforced sulfur block 10. In some embodiments, the protective covering 26 may be sprayed on after removal from the mold 34. In other embodiments, the protective covering 26 may be applied or positioned around mold 34 prior to the addition of sulfur 36.

In other embodiments, the sulfur may be formed into a structurally reinforced sulfur block 10 using compressive force (not shown). This may be carried out by placing pulverized or at least partially powderized sulfur into a compression mold, and applying compressive force for example. In some embodiments, the sulfur block 10 may be formed by addition of a plasticizer in order to add toughness to the solidified sulfur.

An exemplary structurally reinforced block of sulfur is about 64 ft³, weighs about 8,000 pounds, and is dimensioned so that it can be lifted by a variety of makes of telehandlers. A multiple of about 6 such blocks is under the carry weight limitations of most standard trucks or containers. In order to insert, for example, 6 such blocks without stacking into a normal 20 foot container, suitable dimensioning would be about 4 foot high by 5 foot wide by 3 foot deep.

Of great importance in the commercial worthiness of the “mini block” approach to transporting sulfur, is the robustness of the blocks in resisting handling stresses and strains. Elemental sulfur by itself has comparatively low mechanical strength versus normal materials of construction of “block forms” such as concrete, plastic or wood. Given that the modulus of rupture of sulfur is reported in the literature is approximately 200 psi, a rectangular block of sulfur having the dimensions of 3′×4′×5′ is estimated to be capable of withstanding an applied force of ˜184,000 lbs in a standard flexural strength test. Such a block only weighs about 8000 lbs, about 4.4% of the required force to break the block. This suggests that elemental sulfur in the “mini block” form disclosed herein has sufficient mechanical strength to withstand the rigors of handling and transportation via containers. Rounding the mold corners of the block (such as illustrated in FIG. 2) would also reduce the chances of chipping, which will reduce the amount of sulfur dust produced from direct contact with other blocks, the transport container wall, or any lifting equipment, for example.

The structurally reinforced sulfur blocks 10 disclosed herein may be formed from an industrial storage block (not shown) of sulfur. The structurally reinforced sulfur block 10 may also be formed from sulfur byproducts from a well.

Referring to FIG. 9, a method is disclosed having a stage 50 comprising transporting a structurally reinforced sulfur block 10 disclosed herein from a first location to a second location. This stage may further comprise transporting the structurally reinforced sulfur block 10 within a transport container. In one embodiment, transporting may involve intermodal transport, although transporting should be understood as meaning between any two destinations. In some embodiments, transporting further comprises transporting a transport container containing the structurally reinforced sulfur block. Referring to FIG. 11, in another method, in a stage 56, a structurally reinforced sulfur block is loaded into a transport machine, for example into a rail car container. Referring to FIG. 12, in another method, in a stage 58 at least one structurally reinforced sulfur block is removed from a transport container 14 containing at least one structurally reinforced sulfur block 10.

It should be understood that a block includes shapes beyond mere rectangular cube or polyhedrons, for example pyramids, spheres, or any type of solid mass that may be easily handled, transported, and fit in a transport container. However, the provision of dimensions which reduce the chance of chippings or crushed edges/corners is advantageous, in order to avoid the unnecessary creation of hazardous sulfur dust. Further, it may be advantageous to polish or finish the edges and/or sides of a block 10 in order to add further safety.

Exemplary freight handling equipment include, but are not limited to hand pallet trucks, walkie low lift truck, towing tractors, walkie stackers, rider stackers, reach trucks, electric counterbalanced truck, IC counterbalanced truck, sideloaders, telescopic handlers, slip sheet machines, walkie order picking trucks, rider order picking trucks, articulated very narrow aisle counterbalanced trucks, guided very narrow aisle trucks, sod loaders, and freight cranes.

It should be understood that various features of the methods and blocks disclosed herein may be combined with various other features. Blocks made according to the disclosure herein may be made for as little as US $7/metric tonne. This is contrasted with current prilling techniques, which cost US $14-30/metric tonne.

Reference to basic molding in this document refers to filling a mold with liquid sulfur and allowing the sulfur to cool and solidify at room temperature. As discussed above, basic molding produces a sulfur block that has a rigid crust and a crumbly interior, which may include internal void spaces. This roughly 1 inch crust, when grasped, is rigid and gives the block most of its physical strength. In blocks of this type that are large enough to require handling with machines, the strength afforded by the crust is insufficient for the rigors of machine transport. In some embodiments, a structurally reinforced sulfur block may be formed by solidifying liquid sulfur in a mold using sufficiently low external temperatures, such as those experienced outdoors during Canadian winters, in order to form a sulfur block with a crust that is sufficiently thick to afford a molded block sufficient strength and toughness for machine transport.

In the claims, the word “comprising” is used in its inclusive sense and does not exclude other elements being present. The indefinite article “a” before a claim feature does not exclude more than one of the feature being present. Each one of the individual features described here may be used in one or more embodiments and is not, by virtue only of being described here, to be construed as essential to all embodiments as defined by the claims.

1. A method of transporting sulfur, comprising:
transporting a structurally reinforced sulfur block from a first location to a second location by machine.

2. The method of claim 1 in which the structurally reinforced sulfur block is structurally reinforced by layering.

3. The method of claim 2 further comprising forming the structurally reinforced sulfur block by placing sulfur in a plurality of layers in a mold, in which each layer of the plurality of layers is placed in the mold as a liquid after the preceding layer is allowed to solidify.

4. The method of claim 3 in which each layer is 1 inch thick or less.

5. The method of claim 3 in which allowed to solidify comprises after cooling to below 90° C.

6. The method of claim 1 in which the structurally reinforced sulfur block is structurally reinforced by inclusion of reinforcing material.

7. The method of claim 6 in which reinforcing material comprises one or more of mesh, particulate, rod, rebar, and an internal structural frame.

8. The method of claim 6 further comprising forming the structurally reinforced sulfur block by inserting heated reinforcing material when the sulfur block is solid.

9. The method of claim 1 in which the structurally reinforced sulfur block is structurally reinforced by an external structural frame.

10. The method of claim 9 further comprising forming the structurally reinforced sulfur block in the external structural frame.

11. The method of claim 1 in which the structurally reinforced sulfur block is structurally reinforced by annealing.

12. The method of claim 11 in which annealing is done at a temperature between 40 and 90° C.

13. The method of claim 1 in which the structurally reinforced sulfur block is structurally reinforced by application of a protective external coating.

14. The method of claim 1 further comprising transporting the structurally reinforced sulfur block within a transport container.

15. A structurally reinforced sulfur block for machine transport.

16. The structurally reinforced sulfur block of claim 15 structurally reinforced by layering.

17. The structurally reinforced sulfur block of claim 15 structurally reinforced by inclusion of reinforcing material.

18. The structurally reinforced sulfur block of claim 17 in which the reinforcing material comprises at least one of mesh, particulate, rods rebar, and an internal structural frame.

19. The structurally reinforced sulfur block of claim 15 in which the structurally reinforced sulfur block is structurally reinforced by an external structural frame.

20. The structurally reinforced sulfur block of claim 19 in which the external structural frame is dimensioned to stack at least partially within a second external structural frame with the same dimensions as the external structural frame.

21. The structurally reinforced sulfur block of claim 19 in which the external structural frame comprises a bin.

22. The structurally reinforced sulfur block of claim 15 in which the average density of the sulfur in the structurally reinforced sulfur block is at least 1.85 g/cm³.

23. The structurally reinforced sulfur block of claim 15 having a weight of at least 2000 pounds.

24. The structurally reinforced sulfur block of claim 15 in which the structurally reinforced sulfur block is structurally reinforced by a protective coating.

25. A transport container comprising the structurally reinforced sulfur block of claim 15.
